(19) United States
(12) Patent Application Publication
(10) Pub. No.: US 2005/0020447 A1
(43) Pub. Date: Jan. 27, 2005

(54) Catalyst comprising coated substrate

(76) Inventor: Martyn Vincent Twigg, Cambridge (GB)

Correspondence Address: RATNERPRESTIA, P O BOX 980, VALLEY FORGE, PA, 19482-0980, US

(21) Appl. No.: 10/493,771

(22) PCT Filed: Oct. 24, 2002
(86) PCT No.: PCT/GB02/04830

(30) Foreign Application Priority Data
Oct. 26, 2001 (GB) 0125729.4

(51) Int. Cl. B01J 23/42

(52) U.S. Cl. 502/527.18; 502/334

(57) ABSTRACT

A catalyst comprising a substrate (10) comprising at least one passage (20) defined in part by a wall (12), which wall comprising at least one inlet (13) and at least one outlet (14), wherein the sum of the cross-sectional areas of the or each outlet (14) being greater than the sum of the cross sectional areas of the or each inlet (13) whereby the linear flow velocity of a fluid at a point downstream of the at least one outlet (14) is less than the linear flow velocity of the fluid entering the at least one inlet (13), and a catalyst composition coated on the substrate.

The present invention relates to a catalyst comprising a substrate and a catalyst composition coated thereon.

Generally, catalysts for treating vehicular exhaust gases are disposed in an exhaust passage by supporting them on one or more high-surface area, flow-through monolith substrates. Conventional catalyst substrates are made from ceramic or metal.

Presently, the majority of ceramic catalyst flow-through substrates are made from cordierite, but alternative materials include alpha-alumina, mullite, zirconium mullite, barium titanate, porcelain, thorium oxide, steatite, magnesium oxide, boron carbide or silicon carbide. Typically, ceramic substrates are manufactured in a honeycomb arrangement in which adjacent channels extend in parallel along the entire length of the substrate body. The cell density of the honeycomb, i.e. the number of cells per-square-inch (cpsi) (cells per-square-centimetre), and the cellular wall thickness of the ceramic substrate can be varied and each can be chosen for the intended use. Both of these parameters can affect the open frontal area of the substrate, which in turn affects the amount of backpressure in the exhaust system upstream of the substrate (generally, higher back pressure increases engine fuel consumption).

For example, in a 400 cpsi (62 cells per cm²) cordierite ceramic flow-through substrate, the open frontal area of a substrate having 8 thousands of an inch (mil (0.02 cm)) thick cell walls is 70.6%, whereas a 400 cpsi (62 cells per cm²) substrate having 4 mil (0.01 cm) thick cell walls is 84.6%. Generally, increasing the cell density for a standard cell wall thickness decreases the open frontal area. In diesel applications, higher cell densities can lead to the upstream surfaces of the substrate becoming caked with diesel soot. However, decreasing the cellular wall thickness can reduce the durability of the substrate.

Metallic catalyst substrates are made of thin metal foils, generally layers of corrugated metal foil sandwiched between flat metal foil, formed into honeycomb structures by coiling the layers together. The resulting array of channels are sinusoidal in cross-section because they are formed in part from the corrugated foil. One such arrangement is described in U.S. Pat. No. 4,849,274.

Metallic catalyst substrates can have thinner walls and, thus, a higher geometric surface area per unit of volume than ceramic substrates. However, they are generally not as thermally durable as ceramic substrates and getting a catalyst to stick to a substrate surface can be difficult. Metallic substrates can be made from ferritic iron-chromium-aluminium alloys, such as Fecralloy™, or aluminium clad stainless steel foil.

Generally in conventional substrates, the whole of a flow-through monolith is coated with the same catalyst formulation and the exhaust gas contacts the whole formulation at a substantially uniform linear flow velocity. A three-way catalyst (TWC) composition catalyses the oxidation of hydrocarbon (HC) and carbon monoxide (CO) in the exhaust gas of a stoichiometrically-operated gasoline engine to water (H₂O) and carbon dioxide (CO₂) by reaction with nitrogen oxides (NOx) and oxygen (O₂), which NOx is consequently reduced to N₂ by the reaction. A problem with the conventional approach is that both NOx and O₂ in the exhaust gas compete for available HC reductant, and the reaction with O₂ occurs more quickly. Furthermore, relatively high exhaust gas linear flow velocities favour the reaction of HC with O₂ over the NOx/HC reaction. In practice, very often this means that there is little or no reductant available to reduce NOx an inch (2.54 cm) or so into the monolith.

A similar problem arises in diesel applications, where reduction of NOx over a platinum-based lean-NOx catalyst, e.g. platinum on alumina, occurs at about 250° C. to give mainly N₂ and some N₂O. However, lean-NOx conversion is typically limited to a maximum of about 40% because of the competition between NOx and O₂ for HC.

An improvement for reducing NOx could be made by using a more selective catalyst. For example, reducing the platinum loading in a lean-NOx catalyst can increase selectivity for NOx reduction by reducing the selectivity for the HC/O₂ reaction. Alternatively, the nature of the catalyst can be changed from upstream to downstream so that downstream catalysts are increasingly selective for NOx reduction, i.e. to catalyse the reduction of NOx with whatever reductant remains. Coating two or more different catalysts on a monolith is difficult and expensive, but is now commercial practice.

Another improvement could be made by decreasing the linear flow velocity of the exhaust gas over the catalyst. This increases the residence time of the NOx, HC, CO and O₂ over the catalyst and accordingly increases the rate of the HC/NOx reaction, thus improving the effective specificity of the catalyst.

Another improvement could be to use a substrate monolith comprising a large number of relatively short parallel reaction paths, rather than the long aspect ratio provided by a conventional monolithic structure, thereby to reduce the flow rate over the substrate and to increase the rate of the reaction of HC with NOx relative to the HC/O₂ reaction.

Theoretically, one way of reducing exhaust gas linear flow velocity is to use a substrate with a large open frontal area wherein the upstream exhaust gas conduit has a much smaller cross-section than the open frontal area of the substrate. The linear flow velocity of the gas is reduced as it expands into the volume of the passage in which the substrate is disposed. Furthermore, the substrate can have a short aspect ratio relative to conventional substrate monoliths. A catalyst having high specificity for NOx reduction can be used. However, this arrangement is impractical because there is insufficient space on a vehicle to fit a section of exhaust passage of sufficiently large cross-section sufficiently to reduce the linear flow-rate of the exhaust gas.

WO 01/23080 describes an axial/radial—or radial-flow catalytic reactor having inlet and outlet ports and a bed of particulate catalyst disposed e.g. as a cylinder or cone round a central region communicating with one of the ports.

We have now devised a relatively compact substrate that enables an exhaust gas to contact a supported catalyst at lower linear flow velocities than conventional substrates which substrate can be used in combination with catalysts having higher specificity for NOx reduction.

According to one aspect, the invention provides a catalyst comprising a substrate for receiving a flowing fluid, which substrate comprising at least one passage defined in part by a wall, which wall comprising at least one inlet and at least one outlet, wherein the sum of the cross-sectional areas of the or each outlet being greater than the sum of the cross sectional areas of the or each inlet whereby the linear flow velocity of a fluid at a point downstream of the at least one outlet is less than the linear flow velocity of the fluid entering the at least one inlet, and a catalyst composition coated on the substrate.

The invention is based on the scientific principle of conservation of matter in a closed system. Whilst the mass flow of a gas through a passage should not change as the cross-sectional area of the passage changes, the temperature and pressure of the gas, and accordingly the velocity of the gas along the passage, will change.

In one illustrative embodiment, the cross sectional area of the or each passage is greater towards a downstream end relative to an upstream end.

In a further illustrative embodiment, the substrate comprises two or more passages wherein at least one passage has an inlet and all passages have at least one outlet.

For ease of construction, in one illustrative embodiment, the wall of the substrate comprises a tube, although it will be appreciated that the tube need not be straight in the longitudinal direction nor does the cross-section of the tube necessarily have to be circular. Indeed, a tube having at least one flat side, such as a hexagonal cross-section, can improve the rigidity of the tube. However, a circular cross-section is used for convenience. For example, the tube can be frustoconical in shape.

According to another illustrative embodiment, the passage comprises at least one baffle, which can be a narrowing or constriction of the passage, such as a venturi tube, or a dead-end in the passage.

In a further illustrative embodiment the substrate is arranged such that the or each outlet is positioned so that a fluid can exit the at least one passage in a direction other than that in which it enters the at least one passage.

The present invention provides a number of advantages. One advantage is that the linear flow velocity of the gas at a point downstream of an outlet from the at least one passage is reduced so that certain reactions which are catalysed more efficiently at lower linear flow velocities, such as the reduction of NOx by a TWC or diesel lean-NOx catalyst, are promoted.

Another advantage is the fact that there is a relatively low pressure drop across the substrate compared with conventional substrate monoliths. Generally, pressure drop is important because it can affect engine power and therefore performance. Engine tuning can reduce the effects of increased pressure drop on performance, but by using a substrate monolith having minimal pressure drop, these complications are reduced or avoided.

Whilst the internal surface of the wall in part defining the at least one passage can support a catalyst and still benefit from the present invention, in an illustrative embodiment according to the invention the substrate also comprises means for supporting a catalyst in the flow path of exhaust gas exiting the at least one outlet.

In one illustrative embodiment, the support means can include the internal surface of a sleeve disposed around the wall. In order to increase the surface area for supporting the catalyst more significantly, however, we prefer that the support means includes at least one projection extending substantially laterally into the space around the wall. The lateral projection can be supported either by the internal surface of the sleeve, by the wall or both. According to another illustrative embodiment, the or each lateral projection comprises a fin.

An advantage of the embodiment including at least one lateral projection, such as at least one fin, is that it is possible to control the temperature of a supported catalyst because the or each lateral projection can act as a heat sink to dissipate heat from the substrate. This means that the catalyst can treat an exhaust gas more effectively over a wider temperature window including high temperature ‘spikes’ caused, for example, by post-combustion injection of hydrocarbon or hard acceleration.

A further advantage of this arrangement is that the or each lateral projection can muffle noise within the exhaust system so that less material for noise attenuation is required in the exhaust system as a whole.

The above advantages, together with the compact design of the substrate, in particular lend themselves to uses in motorcycles, mopeds, quad bikes, lawnmowers, tractors or boats where space and/or weight can be at a premium.

In aspect, the lateral projection can extend more in the longitudinal direction relative to the at least one passage, or in a more lateral direction relative to the at least one passage, i.e. across it. When the lateral projection is a single fin it can extend in a helix in the longitudinal direction relative to the at least one passage. In an illustrative embodiment the lateral projection is a single fin supported by the wall and the aspect of the helix is predominantly lateral, i.e. the incline on the helix is relatively small.

Of course, in the embodiment where the lateral projection is a fin supported by both the external wall of the tube and a sleeve disposed around the tube, the arrangement should be such so that exhaust gas can exit the substrate. This can be done, for example, by providing at least one outlet in the sleeve, or by adopting the above-described helix arrangement for the lateral projection so that it is open at least at the downstream end. In this last illustrative embodiment, the helix defines a further passage surrounding the passage wall and can increase the residence time of the exhaust gas over a catalyst supported on the internal surfaces of the further passage.

The skilled person will appreciate that other shaped lateral projections can be used, for example the lateral projections can be a plurality of individual discs supported by the wall or the sleeve, or the or each lateral projection can be oval, square or triangular in shape. Equally, the at least one lateral projection can be angled relative to the surface of the wall or sleeve, i.e. the lateral projection can, for example, subtend an acute angle relative to the upstream, i.e. relative to the direction of exhaust gas flow, surface of the wall or sleeve.

The substrate, i.e. the walled body forming the at least one passage, and/or where present, the support means, e.g. the sleeve and/or the at least one lateral projection, is preferably formed from a metal, such as a stainless steel or a ferritic iron-chromium-aluminium alloy. However, it is possible for one or more parts of the substrate to be made from non-metallic materials such as ceramic. For example, the sleeve can be made of a ceramic. The or each lateral projection can be fixed to the external wall of the at least one passage or to the sleeve surface by standard engineering methods, such as by welding.

In one embodiment, the substrate can be formed from a ceramic such as a flow through monolith having one or more inlets blocked, but having all outlets open. Since the ceramic is fluid permeable, gas is able to traverse the walls of the passages to other passages, thus creating a pressure drop downstream of the inlet. The portion of the substrate immediately downstream of the inlet can be coated with a pore-clogging washcoat so that the pressure-drop phenomenon is enhanced as gas contacts the permeable part of the passages downstream.

In an alternative arrangement, a similar effect can be generated in a metal flow through monolith wherein at least one inlet end to a passage is blocked, but the outlet end to that passage is open. The wall of at least one passage having an open inlet and being adjacent to passages having a blocked inlet end has at least one hole allowing fluid communication with the passage downstream of the blocked inlet.

An illustrative embodiment according to the invention can be defined as a catalyst substrate comprising at least one passage for receiving a flowing exhaust gas, which at least one passage is defined in part by a wall and a baffle, the wall including at least one opening for exhaust gas to exit the at least one passage, whereby the combined effect of the baffle and the at least one opening is to reduce, in any dimension, the linear flow velocity of the exhaust gas at a point downstream of the at least one opening relative to the linear flow velocity of exhaust gas entering the at least one passage.

The nature of the catalyst composition coated on the substrate is not important and will depend on the intended purpose. If the catalyst is for use in the exhaust system of a diesel engine, the catalyst composition can be a diesel oxidation catalyst composition or a lean-NOx catalyst composition. For gasoline applications, the catalyst composition can be a TWC formulation, such as in the preferred motorcycle application. For a preferred catalyst composition for motorcycle applications, we refer to our WO 99/42202.

Alternatively, the catalyst composition can be of a NOx-trap, a reformer, e.g. a catalyst for generating hydrogen from an organic compound or by catalysing the water-gas shift, or a catalyst composition for catalysing the selective catalytic reduction of NOx using ammonia. However, the skilled person will appreciate that the catalyst can be used in connection with power plants designed for stationary or propulsive power, and/or which can be fuelled by alternative fuels such as liquid petroleum gas, natural gas, as well as the more common diesel or gasoline fuels. Where the power plant is a fuel cell, the substrate can support a catalyst composition for oxidising CO in a reformate. The use of the substrate in connection with hybrid engines, e.g. able to run selectively on electricity and on gasoline, is also contemplated.

According to a further aspect of the invention, there is provided a power plant including a catalyst according to the invention. For example, the catalyst can be associated with an exhaust system for the power plant, or with a fuel, e.g. gas, inlet for the power plant. The power plant can be an internal combustion engine, for example.

According to a further aspect, the invention provides a vehicle including a power plant according to the invention. Illustrative vehicles include a motorcycle, moped, quad bike, lawnmower, tractor or boat.

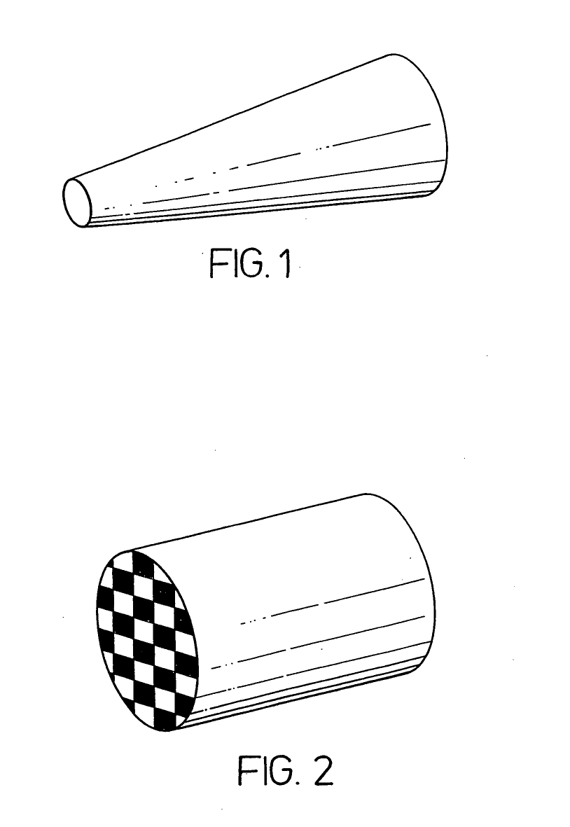

In order that the invention may be more fully understood, illustrative embodiments thereof will now be described with reference to the accompanying drawings, in which FIGS. 1 to 7 are schematic or schematic sectional views of catalyst substrates for use in the present invention.

FIG. 1 shows a frustoconical tube embodiment of the substrate according to the invention, which can be made from a stainless steel. A catalyst composition is coated on the internal surface of the tube.

FIG. 2 shows an embodiment of the substrate for use in the present invention based on a wall-flow ceramic monolith, wherein the upstream inlets of the passages are alternately blocked in such a way that in plan view the arrangement of plugged to open inlets resembles a chequer board. The downstream outlets of all the monolith passages are unblocked. In an alternative arrangement, the upstream ends of the passages immediately downstream of the inlets are coated with a pore-clogging washcoat.

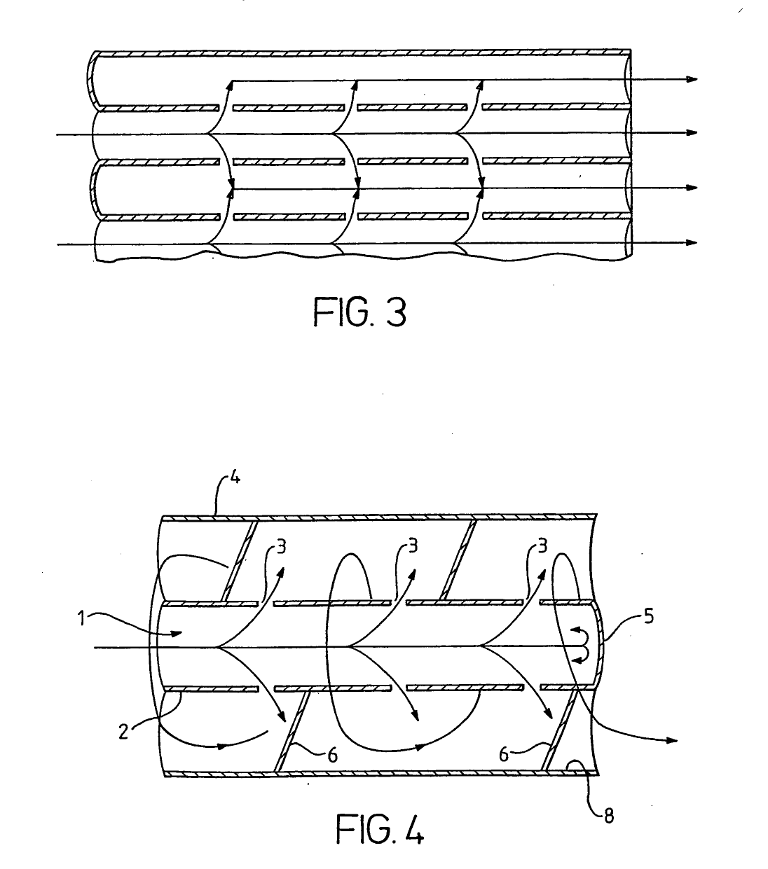

FIG. 3 shows a further substrate embodiment based on a similar principle to that shown in FIG. 2, wherein a metal flow through monolith has alternate inlets blocked, and the walls of adjacent passages open at the inlet end have a plurality of holes to provide fluid communication between passages with open inlet ends and those with blocked inlet ends.

A variation of the substrate shown in FIG. 3, is that the open passage 1 is a tube having a wall 2 including a plurality of outlets 3. A sleeve 4 is concentrically disposed around the central tube 2. The downstream end of the tube is blocked by a baffle 5, and a substantially lateral projection 6 extends helically in the longitudinal direction and is supported between the exterior of the tube wall 7 and the interior surface of the sleeve 8. Fluid, such as a gas, entering the passage is forced through the outlets and is then spun into a vortex as it passes through the passage defined in part by the helically arranged lateral projection. This arrangement increases the residence time of the gas in contact with a catalyst coated on the lateral projection which defines the passage in part.

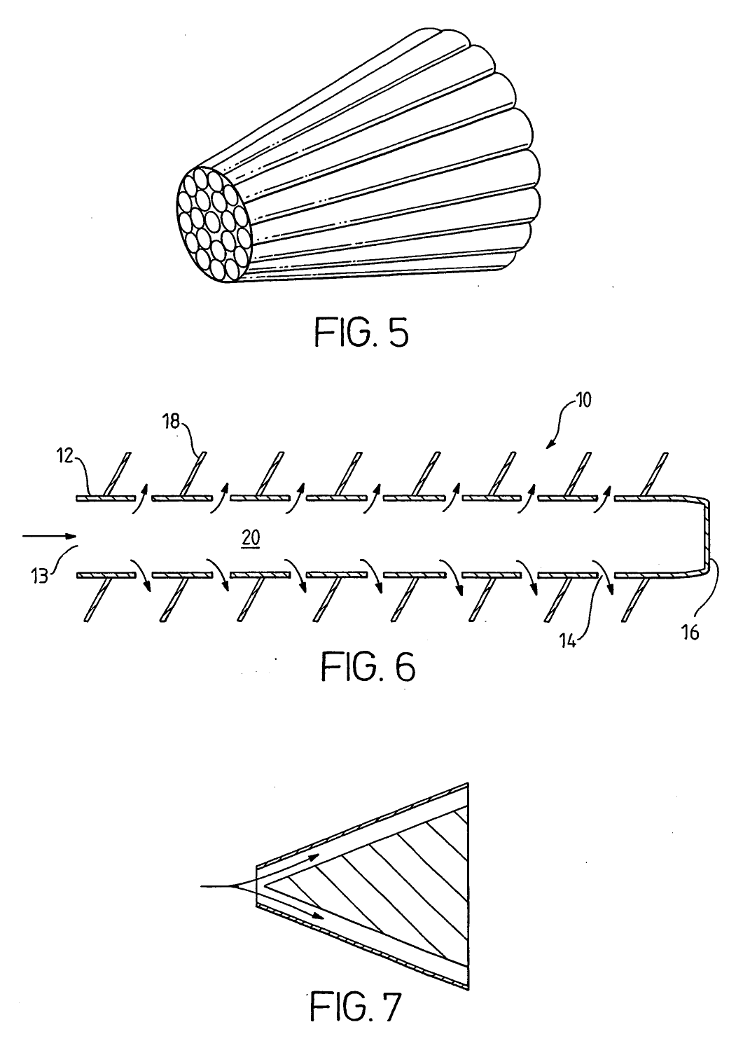

The arrangement shown in FIG. 5 is essentially a plurality of the frustoconical tubes arranged in parallel.

Referring now to FIG. 6, substrate 10 comprises a tube 12 of circular cross-section including a plurality of outlets 14. Tube 12 is made from punched stainless steel plate and is welded into a tubular shape. At one end of the tube 12 is baffle 16 in the form of a closure formed from the stainless steel material. A fin 18, also of stainless steel, is affixed to the exterior surface of the tube 12 by welding. The fin 18 can be one of a plurality of discs welded to the exterior surface of the tube 12, but in the embodiment represented in FIG. 5, the fin 18 is a continuous strip of stainless steel welded to the exterior surface of the tube 12 in a helix.

A washcoat including a TWC composition can be coated on the substrate, e.g. on the internal walls of a passage 20, but most preferably on the or each fin 18. The substrate washcoated with the catalyst composition is then calcined at an appropriate temperature. TWC compositions and methods of preparing washcoats and coated metal substrates are familiar to the person skilled in the art and will not be described further here.

In practice, the substrate coated with the catalyst composition is disposed in the exhaust passage of an internal combustion engine, e.g. a motorcycle exhaust system, such that flowing exhaust gas (represented by the large, bold arrow) can be received in the passage 20 through one end of tube 12. The flowing exhaust gas is prevented from exiting the tube 12 at the other end thereof by baffle 16, and so the exhaust gas (represented by the small arrows) exits the tube via the plurality of outlets 14. The linear velocity of the gas at a point downstream of the passage 20 is reduced relative to the velocity of the exhaust gas entering the passage 20. This has the advantage that reactions catalysed by a catalyst composition supported on the or each fin 18 that occur at an increased rate at lower linear flow velocities than at higher linear flow velocities are promoted.

The embodiment shown in FIG. 7 is a variation on the embodiment shown in FIG. 1 and is here shown in schematic sectional view. Essentially it comprises the frustoconical tube of FIG. 1 with a conical section disposed within the tube, the arrangement being such that the gap between the internal surface of the frustoconical tube and the external surface of the cone is substantially uniform.

The following Example is provided by way of illustration only.

A theoretical model, using published data, was employed to calculate the geometric surface area and space velocity for a given flow of gas through the substrate (hereinafter “Substrate”) described in FIG. 6. This was compared with the values calculated for a flow through metal reactor (hereinafter “Reactor”), of the type generally employed in motorcycle exhausts.

Details of the two monoliths are summarised in the Table below.

| Parameter | Reactor | Substrate |
|---|---|---|
| Length mm | 90 | 43 |
| Diameter mm | 33 | 70 |
| Volume cm³ | 77 | 167 |
| Cpsi (cells cm⁻²) | 100 (15.5) | — |
| SA m² | 0.121 | 0.483 |
| GSA m⁻¹ | 1575 | 2900 |
| Pressure drop millibar (10² Pa) | 2.394* | 2.394* |
| Fin Separation mm | — | 1.0 |
| Space Velocity h⁻¹ | 361,300 | 116,600 |

*Gas flow rate of 28,000 litre h⁻¹

Glossary: cpsi—Cells per square inch
SA—Surface Area
GSA—Geometric Surface Area
Fins Separation—Distance between individual fins (18 in FIG. 6)

The dimensions of the Substrate were chosen so that the back pressure at the given flow rate was equivalent to that of the Reactor. Back pressure is a particularly critical parameter in the design of motorcycle catalysts because of its influence on driveability.

From the Table it can be seen that the Substrate has a geometric surface area almost double that of the Reactor. Also the space velocity for the Substrate, a measure of the effective gas flow through the monolith, is half that of the conventional Reactor. Both these factors allow a longer contact time between gas molecules and the monolith surface, and can lead to increased conversion activity when catalysed.

1. A catalyst comprising a substrate for receiving a flowing fluid, which substrate comprising at least one passage defined in part by a wall, which wall comprising at least one inlets and at least one outlet, wherein the sum of the cross-sectional areas of the or each outlet being greater than the sum of the cross sectional areas of the or each inlets whereby the linear flow velocity of a fluid at a point downstream of the at least one outlet is less than the linear flow velocity of the fluid entering the at least one inlets, and a catalyst composition coated on the substrate.

2. A catalyst according to claim 1, wherein the cross sectional area of the or each passage is greater towards a downstream end relative to an upstream end.

3. A catalyst according to claim 1, wherein the at least one passage comprises two or more passages wherein at least one passage has an inlet and all passages have at least one outlet.

4. A catalyst according to claim 1, wherein at least one passage is a tube.

5. A catalyst according to claim 4, wherein the tube is frustoconical.

6. A catalyst according to claim 1 further comprising at least one baffle for further defining the at least one passage.

7. A catalyst according to claim 6, wherein the at least one baffle is a narrowing or constriction of the at least one passage.

8. A catalyst according to claim 7, wherein the narrowing or constriction of the at least one passage is a venturi tube.

9. A catalyst according to claim 6, wherein the at least one baffle forms a dead-end in the passage.

10. A catalyst according to claim 1, wherein the or each outlet is positioned so that a fluid can exit the at least one passage in a direction other than that in which it enters the at least one passage.

11. A catalyst according to claim 1, wherein the substrate further comprises means for supporting a catalyst in the flow path of a fluid exiting the at least one outlet.

12. A catalyst according to claim 11, wherein the support means comprises an internal surface of a sleeve disposed around the wall.

13. A catalyst according to claim 11, wherein the support means further comprises at least one substantially lateral projection extending into a space on an exterior surface of the wall.

14. A catalyst according to claim 13, wherein the at least one projection is supported by the wall.

15. A catalyst according to claim 11, wherein the support means comprises at least one fin.

16. A catalyst according to claim 15, wherein the at least one fin extends in a helix in the longitudinal direction relative to the at least one passage.

17. A catalyst according to claim 1, wherein the at least one passage is substantially circular in cross-section.

18. A catalyst according to claim 1, wherein the substrate is made, at least in part, from a metal.

19. A catalyst according to claim 1, wherein the catalyst composition is a three-way catalyst composition.

20. A catalyst according to claim 1, wherein the catalyst composition is a diesel oxidation catalyst, a lean-NOx catalyst composition or a catalyst for catalysing the selective catalytic reduction of NOx by ammonia.

21. A catalyst according to according to claim 1, wherein the catalyst composition is a NOx-trap composition.

22. A power plant including a catalyst according to claim 1.

23. A power plant according to claim 22 including an exhaust system comprising the catalyst.

24. A power plant according to claim 23, which is an internal combustion engine.

25. A vehicle including a power plant according to claim 24.

26. A vehicle according to claim 25, which is a motorcycle, moped, quad bike, lawnmower, tractor or boat.

27. A catalyst comprising a substrates, which substrate comprising at least one passage for receiving a flowing exhaust gas, which at least one passage is defined in part by a wall and a baffle, the wall including at least one openings for exhaust gas to exit the at least one passage, whereby the combined effect of the baffle and the at least one opening is to reduce, in any dimension, the linear flow velocity of the exhaust gas at a point downstream of the at least one opening relative to the linear flow velocity of exhaust gas entering the at least one passages, and a catalyst composition coated on the substrate.

28. A catalyst according to claim 18, wherein the metal is stainless steel.
